(19) United States
(12) Patent Application Publication
(10) Pub. No.: US 2008/0300846 A1
(43) Pub. Date: Dec. 4, 2008

(54) METHODS AND APPARATUS FOR HARDWARE SIMULATION AND DESIGN VERIFICATION

(76) Inventors: Stephan Voges, Foster City, CA (US); Mark Andrews, San Francisco, CA (US)

Correspondence Address: LAW OFFICE OF JAMES TROSINO, P.O. BOX 200, YONKERS, NY, 10703, US

(21) Appl. No.: 12/131,067

(22) Filed: May 31, 2008

Related U.S. Application Data
(63) Continuation of application No. 09/521,280, filed on Mar. 7, 2000, now abandoned.

(51) Int. Cl. G06F 17/50

(52) U.S. Cl. 703/14

(57) ABSTRACT

A scripting approach to managing the test bench complexity issue is provided. Partitioning the functionality of a test bench between Verilog and a scripting language allows for a significant reduction in compile times during ASIC verification. If done correctly, partitioning also offers great potential for re-use of test bench components. The Tcl language was chosen as a basis for implementing a library of PLI routines that allow fully customizable interpreters to be instantiated in Verilog test benches. This library allows multiple Tcl interpreters to be instantiated in a Verilog simulation. The Tcl interpreters can interact with the simulation and cause tasks to be executed in the Verilog simulation. It has been found the TCL_PLI library is extremely valuable in speeding up verification efforts on multi-million gate ASICs.

### REFERENCE TO RELATED APPLICATIONS

This application is a continuation of U.S. patent application Ser. No. 09/521,280, filed Mar. 7, 2000, which is incorporated by reference herein in its entirety

### BACKGROUND OF THE INVENTION

1. Technical Field

The invention relates to application specific integrated circuits (ASICs). More particularly, the invention relates to a framework for reusable, run time configurable test benches for the verification of ASIC designs.

2. Description of the Prior Art

As ASIC complexity keeps increasing, the time spent in design and maintenance of test benches has grown to become a disproportionately large part of the total design effort. In an ASIC verification engine, such as provided by VERILOG, test benches have become slow to compile and cumbersome to maintain.

The traditional approach to test bench development and ASIC verification is to write a single test bench that contains a number of tasks that exercise different aspects of the designs. Team members add new tasks as the verification effort continues, and tests are run by calling different sets of tasks in different order, depending on the functionality being tested.

One problem with this approach is that the test bench must be recompiled for every new simulation. Even though compiled simulators offer features such as incremental compilation, in which only the code that changed is recompiled, this still means that a lot of time is spent compiling test benches.

Initial efforts to reduce this problem involved using configuration files. In this approach, one tries to make the test bench code to be all things to all people. Test benches typically contain complicated case statements and if-then-else sequences. These are controlled by parameters that are read from a text configuration file when the simulation is launched.

This approach eliminates the need to recompile test benches repeatedly, but introduces an even worse problem, i.e. test benches become extremely complicated, very difficult to maintain, and very application specific. Often, when new functionality is added to a test bench, it has side effects that cause other tests to break. At the end of the project, one has a test bench that very few people understand, and that is so convoluted that there is no possibility of reuse.

It would be advantageous to provide an approach to ASIC verification in which test benches do not become extremely complicated, very difficult to maintain, or very application specific. It would be of additional advantage in such approach if, when new functionality is added to a test bench, it does not introduce side effects that cause other tests to break. Further, at the end of the project, one should have a test bench that anyone can understand, and that is not so convoluted that there is no possibility of reuse.

### SUMMARY OF THE INVENTION

A scripting approach to managing the test bench complexity issue is provided. Partitioning the functionality of a test bench between VERILOG and a scripting language allows for a significant reduction in compile times during ASIC verification. If done correctly, partitioning also offers great potential for re-use of test bench components.

The Tcl language was chosen as a basis for implementing a library of PLI routines that allow fully customizable interpreters to be instantiated in VERILOG test benches. This library allows multiple Tcl interpreters to be instantiated in a VERILOG simulation. The Tcl interpreters can interact with the simulation and cause tasks to be executed in the VERILOG simulation.

It has been found the TCL_PLI library is extremely valuable in speeding up verification efforts on multi-million gate ASICs.

### BRIEF DESCRIPTION OF THE DRAWINGS

FIG. 1 is a block schematic diagram that illustrates the required interaction between the VERILOG simulation and a Tcl interpreter according to the invention.

### DETAILED DESCRIPTION OF THE INVENTION

The invention provides a solution to the problem of providing a reusable test bench for ASIC design verification by making the configuration files more powerful, so that some of the complexity that is coded in VERILOG is shifted over to something that is evaluated at run time. In essence, a scripting language is provided that interacts with the simulation.

With this approach, one can design a simple test bench which contains a number of tasks that handle low level interaction with the device under test. If these tasks are called from a scripting language, one can develop different verification scripts; each test tailored to verifying a specific aspect of the design.

A key difference from the prior art configuration file approach is that the intelligence that determines the ordering of events is moved from VERILOG to a script file that is interpreted at run time. Different people can use the same test bench to test a design in completely different ways. They have the benefit of significantly reduced need for recompilation, and different people on the verification team can be completely insulated from one another. Each person can develop their own verification script, and changes to that script only affect their own simulations.

### Tcl as a Choice of Scripting Language

The initial approach taken was to extend the configuration files that were already in use to handle simple conditional and looping constructs, and to extend the PLI routines that were in use to process these configuration files to become a simple interpreter.

It was decided to investigate the feasibility of using Tcl as a scripting language (see J. Ousterhout, Tcl and the Tk Toolkit, p. xvii, Addison-Wesley, (1994)). This turned out to be a very good idea. After many attempts to write custom interpreters for various tools, it was decided to write the ultimate, reusable and embeddable interpreter. Tcl appeared to have all the characteristics that are necessary to implement the invention, i.e. it was already developed, it was free, it was easily extendable, and it was easy to embed in an application.

### The Obstacle

There was a problem to overcome:

The VERILOG language is extended through function calls. If a user needs new functionality, it is implemented in C, and the PLI API is used to make it available as a new function that can be called from VERILOG. Tcl is also extended through function calls, but new functionality is implemented in another compiled language (typically C) and is linked into Tcl as a new Tcl function.

A system was implemented in which the VERILOG simulation starts up a Tcl interpreter and instructs it to run a script. This implied a PLI function call. At some point the Tcl interpreter encounters a function that is mapped to a certain VERILOG task. It then must pass control back to VERILOG so that the task could be executed. This implies that the PLI call that invokes the interpreter must return, leaving the problem of how to resume execution of the Tcl script after executing the VERILOG task.

In addition to extending the functionality of configuration files through the use of a scripting language, it was necessary to invent a system through which one could pass control between VERILOG and Tcl, through function calls on either side. In this way, the VERILOG code controls when Tcl interpreters are invoked, but the Tcl interpreters cause VERILOG tasks to be executed (implying that a PLI call needs to return), while retaining the state of the Tcl interpreter so that it could resume execution of the Tcl script after the VERILOG task completed.

### The Solution

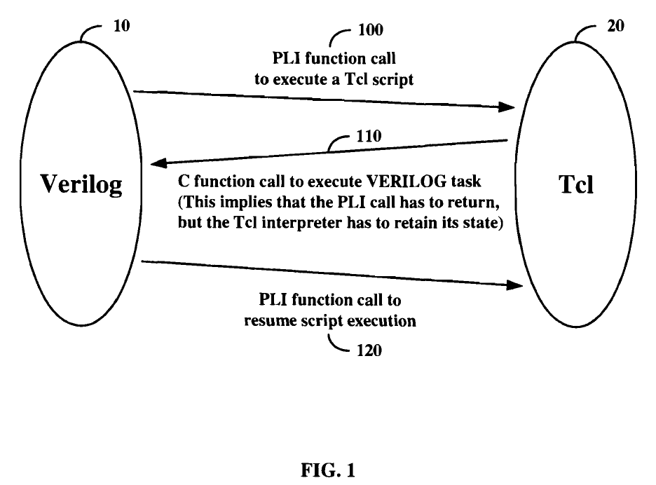

The preferred embodiment of the invention solves this probler-ri by implementing a simple client-server model, in which the Tcl server runs on a separate thread from the VERILOG simulation. FIG. 1 is a block schematic diagram that illustrates the required interaction between the VERILOG simulation 10 and a Tcl interpreter 20. Synchronization between the VERILOG simulation and the Tcl server is performed via a set of semaphores. This allows control to be passed freely between VERILOG and Tcl. The VERILOG code determines when Tcl interpreters are invoked and Tcl interpreters can randomly cause VERILOG tasks to be executed. Thus, a PLI function call executes a Td script (100), a C function call executes a VERILOG task (110), and a PLI function call resumes script execution (120).

The TCL_PLI library allows any number of Tcl interpreters to be instantiated in a VERILOG simulation. Every interpreter is completely customizable. PLI functions initialize interpreters and define new Tcl functions that are mapped to VERILOG tasks. PLI functions also start running scripts on the Tcl interpreters and pass control between VERILOG and Tcl.

The VERILOG tasks have access to arguments passed to the Tcl functions that invoked them, allowing information to be passed from Tcl to VERILOG. The VERILOG tasks also have the ability to control the return values of their Tcl counterparts, allowing information to be passed from VERILOG to Tcl. PLI routines are also provided that allow direct sharing of information between Tcl and VERILOG, as well as between different Tcl interpreters.

### Interaction Between VERILOG and Tcl

At the core of the TCL_PLI library are four PLI functions: $tcllnit, $tclExec, $tclGetArgs, and $tclClose.
$tcllnit creates and initializes a new Tcl interpreter. It defines the new Tcl functions that are used to invoke VERILOG tasks, maps them to specific tasks, and defines how many arguments they take.
$tclExec passes control from VERILOG to the Tcl server. It launches a new script or resumes execution of a script that was stalled when the interpreter encountered a function that was mapped to a VERILOG task. $tclExec returns under one of three conditions: when an error occurs, when the script ends, or when a function is encountered that is mapped to a VERILOG task.
$tclGetArgs accesses the argument values that were passed to an extended Tcl function.
$tclClose destroys a Tcl interpreter and frees the resources with which it is associated.

The following code segment (Table A) shows how an interpreter is created and initialized in VERILOG. The interpreter has three extended Tcl commands (b_write, b_read and b_wait_irq) that are mapped to VERILOG tasks. These commands allow scripts running on the interpreter to write data on a bus, read data from a bus, or wait for an interrupt to occur on the bus.

TABLE A

| 1 parameter | |
|---|---|
| 2 BUS_WRITE | = 1, |
| 3 BUS_READ | = 2, |
| 4 BUS_WAIT_IRQ | = 3; |

| 5 initial | | |
|---|---|---|
| 6 begin: processor_model | | |
| 7 integer tcl_handle, | | |
| 8 tcl_command, tcl_return_value; | | |
| 9 // Initialize interpreter that | | |
| 10 // knows about the three | | |
| 11 // extended Tcl commands: | | |
| 12 tcl_handle = $tclInit ( | | |
| 13 “processor”, tcl_command, | | |
| 14 tcl_return_value, | | |
| 15 “b_write”, | BUS_WRITE, | 2, |
| 16 “b_read”, | BUS_READ, | 1, |

| | |
|---|---|
| 17 “b_wait_irq”,BUS_WAIT_IRQ, | 0 |

18 );
19 if (tcl_handle == 0)
20 begin
21 $display (“Init error.”);
22 $finish;
23 end

On lines 1 to 4, three integer parameters are defined that represent the three extended Tcl commands in VERILOG. Lines 7 and 8 define three variables that are used to communicate between VERILOG and Tcl. tcl_handle stores the handle of this interpreter. Each interpreter has a unique handle. It is returned by the $tcllnit PLI function and is used by all other TCL_PLI functions to identify the interpreter that is being addressed. tcl_command is used by TCL_PLI to indicate to VERILOG which extended Tcl function had been encountered while executing the script. It also indicates the completion status of the Tcl script when execution of the script ends. tcl_return_value is used by VERILOG to communicate the return values of tasks back to the calling Tcl functions. On lines 12 to 18, the call to $tcllnit initializes the interpreter. It identifies the variables tcl_command and tcl_return_value to TCL_PLI. It also defines the extended Tcl functions b_write, b_read and b_wait_irq. $tcllnit associates an integer value with each extended Tcl function and stores the number of arguments that each extended Tcl function should expect. $tcllnit can take a variable number of arguments to allow definition of any number of extended Tcl functions.

The return value of $tcllnit contains the handle of the newly created Tcl interpreter. If the value is zero, this is an indication that an error occurred while creating and initializing the interpreter. The test on line 19 confirms that the call to $tcllnit completed successfully.

The following code segment (Table B) indicates how a script is executed on a Tcl interpreter and how control is passed between VERILOG and Tcl.

TABLE B

24 while ($tclExec (tcl_handle,
25 “example.tcl”))
26 begin
27 tcl_return_value = 0;
28 case (tcl_command)
29 BUS_WRITE:
30 bus_write (tcl_handle);
31 BUS_READ:
32 bus_read (tcl_handle,
33 tcl_return_value);
34 BUS_WAIT_IRQ:
35 bus_wait_irq;
36 endcase
37 end // while
38 if (tcl_command != 0)
39 begin
40 $display (
41 “Error in Tcl script!”);
42 $finish;
43 end
44 $tclClose (tcl_handle);
45 end // processor_model

When $tclExec is encountered the first time (line 24), the Tcl server is idle. This is an indication that it should start executing the script “example.tcl”. As mentioned earlier, $tclExec returns under one of three conditions: if an error occurs, if the script ends, or if an extended Tcl function is encountered. A non-zero return value indicates that an extended Tcl function had been encountered. A return value of 0 indicates that the script has ended or that an error occurred. In the case where an extended Tcl function is encountered, the Tcl interpreter stalls until the next call to $tclExec informs it that the VERILOG task has been executed.

The while loop (lines 24 to 37) continues looping as long as the return value of $tclExec remains positive. This means that the simulator continues executing VERILOG tasks as they are encountered in the Tcl script that is being executed. If $tclExec is called when the Tcl server is not idle, it assumes that execution of the current script should continue. $tclExec checks that the script name passed to it matches the name of the script being executed and returns an error value if this is not the case.

Not all VERILOG tasks have meaningful return values. Therefore, tcl_return_value is initialized to zero to ensure that an undefined value is not eventually returned to the Tcl interpreter (line 27).

Whenever $tclExec returns a non-zero value, the tcl_command variable contains the integer value corresponding to the extended Tcl function that was encountered in the script. The case statement on line 28 calls the VERILOG task associated with this Tcl function.

Once the VERILOG task completes, the while loop continues with another call to $tclExec. $tclExec again returns when it encounters an extended Tcl command, reaches the end of the script, or encounters an error. The result is that the while loop causes the whole Tcl script to be executed, and VERILOG tasks are called in the order determined by the execution of the Tcl script.

When the while loop terminates, it is appropriate to check that no error occurred (line 38). When $tclExec returns zero (causing the while loop to terminate), the tcl_command variable contains an exit code indicating either normal termination (end of script reached) or abnormal termination (due to an error in the script).

At this point, the Tcl interpreter can be deleted if it is no longer required (line 44). It should be noted that the same interpreter can be used repeatedly. Scripts can also be run on the interpreter from different points in the VERILOG code. TCL_PLI generates an error if an attempt is made to run multiple scripts on one interpreter simultaneously. Interpreter state information (such as variable values and procedure definitions) is preserved until the interpreter is destroyed through a call to $tclClose.

The following code segment (Table C) shows the definition of the VERILOG tasks that are called under control of the Tcl interpreter.

TABLE C

49 task bus_write;
50 input [31:0] tcl_handle;
51 integer address, data;
52 begin
53 $tclGetArgs (tcl_handle,
54 address, “i”,
55 data, “i”
56 );
57 // Simulate the write cycle
58 // on the bus
59 end
60
61 task bus_read;
62 input [31:0] tcl_handle;
63 output [31:0] data;
64 integer address;
65 begin
66 $tclGetArgs (tcl_handle,
67 address, “i”
68 );
69 // Simulate the read cycle
70 // on the bus
71 data = data_read_from_bus;
72 end
73
74 task bus_wait_irq;
75 begin
76 @(bus_irq);
77 end

A VERILOG task can gain access to the arguments of the Tcl function by which it is invoked. For this purpose, the handle of the interpreter is passed to these tasks (line 50). A call to $tclGetArgs is used to transfer this information from Tcl to VERILOG (line 53). $tclGetArgs can handle integer or string arguments, and performs the appropriate conversions.

The bus_read VERILOG task illustrates how the return value of a Tcl function is set up in the VERILOG task (lines 71 and 33). TCL_PLI assumes that the return value is an integer. The bus_wait_irq task illustrates a simple case where the Tcl interpreter can be stalled while waiting for an event in the simulation (line 76).

The following (Table D) is a sample Tcl script that can be run in the VERILOG example shown above. It illustrates how the execution order of the VERILOG tasks are completely controlled from Tcl. In essence, the Tcl script is in complete control of the simulation in the same way that software controls the hardware on which it is run.

TABLE D

```
  1 # Write to a register, wait
  2 # for an interrupt and read back
  3 # a cause:
  4 puts “$::vname @ $::vtime: \
  5  Writing 0xaa to address 0x05:”
  6 b_write 0x05 0xaa
  7 puts “$::vname @ $::vtime: \
  8  Waiting for interrupt...”
  9 b_wait_irq
10 puts “$::vname @ $::vtime: \
11  Interrupt received”
12 puts [format “Address 0x05 now \
13  contains %x” [b_read 0x05]]
14
15 # Write to another register,
16 # then poll until bit 1 changes:
17 puts “$::vname @ $::vtime: \
18  Writing 0xff to address 0x0a:”
19 b_write 0x0a 0xff
20 set bit_1 0x0
21 while {$bit_1} {
22  # Read 0x0a and check the LSB:
23  set bit_1 \
24  [expr [b_read 0x0a] && 0x01]
25  puts “$::vname @ $::vtime: \
26  Bit 1 value is $bit_1”
27  }
28 puts “$::vname @ $::vtime: \
29  Value changed!”
```

The variables vname and vtime are defined by the TCL_PLI library. vname contains the name of the interpreter (passed as the very first argument to $tcllnit). It is useful to determine the source of a message. vtime contains the current simulation time, which is very useful for tracing simulator messages back into waveforms.

### Behind the Scenes

As mentioned previously, the Tcl interpreter is run on a separate thread from the VERILOG simulation. A call to $tcllnit causes a secondary thread to be created, on which the Tcl server runs. The Tcl server creates and initializes a new Tcl interpreter, and then enters a loop in which it waits for and executes commands received from the PLI functions.

The following C code segment (Table E) is a simplified version of the command loop in the Tcl server.

TABLE E

```
  1 /* Wait for and service requests
  2  to run scripts */
  3 runServer = 1;
  4 while (runServer)
  5  {
  6  /* Pass control to the VERILOG
  7  thread */
  8  sem_post (&t->t2v);
  9  /* Wait for an instruction from
10  the VERILOG thread */
11  sem_wait (&t->v2t);
12  switch (t->serverCommand)
13  {
14  case TC_RUNSCRIPT:
15  t->serverStatus =
16  tclServer_runScript (t);
17  break;
18  case TC_CLOSE:
19  runServer = 0;
20  t->serverStatus = TS_DONE;
21  break;
22  case TC_ADDCOMMAND:
23  /* Add new commands to
24  interpreter */
25  break;
26  case TC_LINKVARS:
27  /* Link with VERILOG
28  variables */
29  break;
30  case TC_SHAREVARS:
31  /* Link with variables from
32  other interp */
33  }
34 }
```

Once the Tcl server is initialized, it enters the command loop and immediately posts the t2v semaphore to the PLI to indicate that it is ready to accept a command. It then waits for the v2t semaphore. Upon receipt of the v2t semaphore, it examines the serverCommand member of its defining structure to determine what command was issued and executes the command. When the command is completed, the loop starts again.

On the VERILOG thread, a PLI function sends a command to the Tcl server by setting up the serverCommand member of the server's defining structure and then posts the v2t semaphore. The PLI function then waits for the t2v semaphore as an indicator that control is being passed back to VERILOG.

The following sequence takes place if the Tcl script in the previous example is executed:
When $tclExec is called from the VERILOG simulation the first time (Tcl server is idle), it instructs the Tcl server to start executing the script, and then waits for the t2v semaphore. The Tcl server executes lines 1 through 5 of the script. When it reaches line 6, which contains the extended command b_write, it calls the function tclServer_verilogCall. This function is called for all extended commands that are mapped to VERILOG tasks. tclServer_verilogCall saves the relevant information in its defining structure, posts the t2v semaphore, and then waits for the v2t semaphore.
When $tclExec receives the t2v semaphore, it synchronizes linked variables and returns to VERILOG. This allows the simulator to enter the while loop in which it executes the tasks associated with extended Tcl functions (lines 24 to 37 of the VERILOG example). When the task associated with b_write completes, $tclExec is again called. This time the Tcl server is not idle, so $tclExec assumes that execution of the script should resume. It synchronizes linked variables, posts the v2t semaphore, and waits for the t2v semaphore.
tclServer_verilogCall receives the v2t semaphore and returns, allowing execution of the Tcl script to continue. This process repeats itself until the script completes. When this happens, the Tcl server indicates this to the PLI when posting the t2v semaphore. This time, when $tclExec returns, the VERILOG while loop terminates.

The following C code segment (Table F) shows a simplified version of tclServer_verilogCall, the function that is called by the Tcl interpreter when it encounters an extended command.

TABLE F

```
  1 int tclServer_verilogCall (...)
  2  {
  3  /* Store the command value for
  4  the VERILOG thread */
  5  t->commandValue =
  6  command->value;
  7  /* Store the argument array
  8  and count in the interpreter
  9  struct to make it accessible
10  to tclGetArgs: */
11  t->argc = argc;
12  t->argv = argv;
13  /* Semaphore VERILOG */
14  sem_post (&t->t2v);
15  /* At this point control has
16  been passed back to VERILOG,
17  where the functionality is
18 being simulated. Once done,
19  the main thread will
20  semaphore this thread to
21  continue. */
22  /* Wait for semaphore from
23  VERILOG */
24  sem_wait (&t->v2t);
25  /* Set up the return value */
26  sprintf (message, “%d”,
27  t->retVal);
28  Tcl_SetResult (t->interp,
29  message, TCL_VOLATILE);
30  return TCL_OK;
31  }
```

It is important to note that, even though TCL_PLI is multi-threaded, and that every interpreter is run on a dedicated thread, the essential single threaded nature of VERILOG simulations is maintained. Only one call to $tclExec can be reached in the VERILOG simulation at any given time. The VERILOG simulation stalls until this call returns, which occurs when the Tcl interpreter calls tclServer_verilogCall or when the script completes. tclServer_verilogCall, on its part, only returns when the next call to $tclExec is encountered in the VERILOG simulation. This means that, even though many Tcl scripts may be in the process of execution at any given moment in time, only one of them or the VERILOG code itself is running at that moment. All event scheduling and execution order is still under the control of the simulator.

It should also be noted that the Tcl server executes scripts in zero simulation time. Simulation time does not advance for the duration of a call to $tclExec. Simulation time advances normally while the VERILOG tasks invoked from Tcl are executed

The TCL_PLI library

The following discussion provides a brief overview of the PLI functions available in the EFI_PLI library. The $tcllnit, $tclClose, $tclExec and $tclGetArgs PLI functions have already been discussed in detail and are not listed again in this section.

$tclLinkVariables and $tclShareVariables

$tclLinkVariables allows direct sharing of variables between VERILOG and Tcl. It links a list of VERILOG variables with a list of Tcl variables. The TCL_PLI library then automatically keeps these variables synchronized until the interpreter is deleted. $tclLinkVariables has support for integer and string variables, and can mark variables as read-only in the Tcl interpreter, meaning that they can be modified in VERILOG, but not in Tcl.

$tclShareVariables allows direct sharing of variables between two different Tcl interpreters, without any connection to VERILOG. After a call to $tclShareVariables, the list of Tcl variables in both interpreters are automatically synchronized by the TCL_PLI library, until one of the interpreters is deleted.

$tclSetMCD and $tclAddMCD

$tclSetMCD and $tclAddMCD allow the Tcl interpreter access to multi-channel descriptors in the VERILOG simulation. This allows the user to redirect messages from the Tcl interpreter into log files that also record messages directly from the simulation, which is critical for preserving the order in which messages were generated. Any VERILOG multi-channel descriptor can be associated with a Tcl interpreter. It an interpreter has an associated MCD, its built-in puts command is modified, causing all output to stdout to be redirected to the multi-channel descriptor. This makes it very easy to open a log file and set up an MCD that causes all messages from the simulation (both from VERILOG and Tcl) to be printed to stdout, as well as being recorded in a log file.

$tclSetErrorReg

$tclSetErrorReg allows the user to identify one register in the VERILOG simulation that is linked to any error occurring in any interpreter or in TCL_PLI. If any error occurs, the value of this register is changed, allowing the simulation to react to the error immediately.

$tclWarnOnX

As with any software language, Tcl has no concept of X or Z values. The default behavior of TCL_PLI causes execution of the Tcl script to be terminated under any of the following conditions:

If the return value of an extended Tcl function is X or Z, or if any linked variable is X or Z at a point where it is evaluated in the script.

For purposes of the preferred embodiment of the invention, this is correct and desirable behavior. In the presently preferred embodiment of the invention, X and Z values should never propagate into the software domain because software can not handle these values. However, some users of TCL_PLI do not share this opinion, and hence the existence of $tclWarnOnX. Calling $tclWarnOnX causes TCL_PLI to print a warning message under any of the previously described conditions. Execution of the script continues. If the variable in question is an integer, its Tcl value is considered to be zero. If it is a string, its Tcl value is “Zz”.

Note that only a warning message is generated. In a simulation that prints many messages, this message can easily scroll off the screen before being noticed. The misinterpretation of the VERILOG value in Tcl can ultimately cause all sorts of strange behavior and may cause problems the user who decides to use $tclWarnOnX.

### EXAMPLE

### PCI_TCL

The preferred embodiment of the invention includes a module that instantiates Synopsys LMC source models for a PCI master and a PCI slave together with two Tcl interpreters. The tasks supplied with the PCI models are mapped to extended Tcl functions, allowing one to execute Tcl scripts that interact with other devices on a PCI bus. The VERILOG code causes one of the Tcl interpreters to start executing a script when it senses an interrupt on the PCI bus. This allows easy modeling of interrupt service routines written in Tcl. Execution of a Tcl script can be linked to an interrupt by waiting in the VERILOG code for the interrupt to occur before entering the while loop calling $tclExec.

The two interpreters in the PCI master have to compete for access to the bus. This is accomplished through a simple gating mechanism that checks whether the bus is busy before calling a task that starts a transaction on the bus. If the bus is busy, it waits for the current transaction to complete before starting the new one. This arrangement models actual software behavior very well, where several processes running on a CPU have to compete for access to the PCI bus, with no guarantee on the order in which accesses takes place.

The PCI_TCL module allows both interpreters to load data files directly into the LMC slave memory (in zero simulation time). Data can also be dumped from the slave memory to a file. Both interpreters can execute memory or I/O transactions on the bus. Two extended Tcl functions are used for bursting commands: the one executes the address phase of a burst while repeated calls to the other executes one data cycle per call. An encapsulating Tcl procedure takes an address, byte count, and byte array and performs a corresponding burst read or write on the PCI bus by appropriately calling the underlying extended Tcl functions.

The PCI_TCL module allows extensive testing of any PCI based device without writing a single line of VERILOG code for the test bench. The preferred embodiment of the invention also comprises a library of Tcl procedures that simplifies tasks such as configuration of PCI devices.

### TCL_PLI in Practice

The TCL_PLI library has been used to verify a 600 k gate design and is currently being used on two designs, both of which are larger than one million gates. All of these designs are PCI based ASICs. Using the PCI_TCL module has made it possible to write elaborate scripts that interact with the device under test in very much the same way as software would interact with the real hardware.

Tcl interpreters were also used in modules that interact with other ports on the device under test. In each case, VERILOG tasks were written that know how to interact with a port at a low level. The higher level behavior of the test module is then controlled by a Tcl script. This allows one to change the behavior of test modules radically by running differing Tcl scripts on them.

In the presently preferred test benches, there typically is a master Tcl interpreter that controls all test modules that interact with the device under test. It determines which Tcl scripts are executed when and on what module. This approach provides centralized control over an extremely configurable test bench.

### Pitfalls

There are a number of pitfalls to watch out for when using the TCL_PLI library. Most important are some issues related to the simulator. The presently preferred embodiment of the invention comprises use of the TCL_PLI library with Synopsys' VCS simulator. With VCS version 4.0.3 it was necessary to compile through C code. VCS allows compilation through C, assembler, or directly to object code. Compilation through C is the slowest, but Synopsys advises to compile through C if using multi-threaded PLI. Not doing this causes immediate core dumps, even when the TCL_PLI library is linked in, but not used. The presently preferred embodiment of the invention comprises VCS version 5.0.1. This version does allow one to compile directly to assembler or object code. It should also be mentioned that, other than the penalty of slower compile times, VCS 4.0.3 works perfectly well with TCL_PLI.

Following is a list of compile time options for VCS that are needed when using the TCL_PLI library:
—Xstrict: Prevents VCS from using resources that are used by the multi-threading library.
—Ipthread—Iposix4: Link with the Posix threading support libraries.

TCL_PLI has also been used with Cadence VERILOG-XL version 2.5.

One of the most common problems encountered by first-time users, is that they forget to assign a default value for the return value register in the while loop that executes the Tcl script. TCL_PLI has no way to distinguish whether a return value is used, and always complains if a return value is X or Z. Therefore, a default value should always be assigned. A problem that was anticipated, but that is not encountered frequently, is with Tcl bugs in long running simulations. Because Tcl is an interpreted language, a syntax error is only detected when the interpreter encounters the statement that contains the error. There were concerns that a simulation could start off that would run very long, only to have it die near the end due to a bug in the Tcl script. The way that this problem is presently managed is to develop scripts incrementally, thereby ensuring that long-running simulations are performed with proven Tcl code.

### Conclusion

The preferred embodiment of the invention significantly reduces time spent recompiling test benches. Test benches are a simpler, and consist of modular, reusable modules that are easy to maintain. New tests are implemented in new, separate scripts, eliminating the problem where addition of new tests causes existing tests to break.

The Tcl scripts themselves are often reusable. When module level testing is performed, functionality between Tcl and VERILOG is partitioned such that the Tcl scripts are reusable in system level testing. As an example, a Tcl interpreter interacting with a module uses extended Tcl functions that take the same arguments and return values as matching functions in the PCI_TCL module, even though it is not interacting with a PCI bus. This way, the scripts that are developed for testing the module can be rerun without modification in system level tests.

In one use of the invention, it was possible to reuse a complicated Tcl script written for a project that was cancelled. The module was initially written to test a memory controller by performing random reads and writes and automatically verifying data integrity. When it was later necessary to design logic that had to access system memory through a PCI bus, the script was reused without modification.

Another embodiment of the invention allows the porting of Tcl scripts to real hardware. This enables a verification suite to run on ASICs when they return from the foundry.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. a method for providing a design test bench, the method comprising:
providing a single executable program adapted to create a primary thread and a secondary thread, the primary thread running VERILOG code on a simulator that runs VERILOG code, the secondary thread running an interpreter that interprets a scripted routine comprising a user-defined call that is mapped to a VERILOG task;
providing a user-defined VERILOG function associated with the interpreter;
upon encountering the user-defined function, passing control from the simulator to the interpreter to interpret the scripted routine; and
upon encountering the user-defined call, passing control from the interpreter to the simulator.

2. The method of claim 1, further comprising synchronizing the simulator and the interpreter via semaphores.

3. The method of claim 1, further comprising directly sharing variables between the simulator and the scripted routines.

4. A method for providing a design test bench, the method comprising:
providing a single executable program adapted to create a primary thread and one or more secondary threads, the primary thread running VERILOG code on a simulator that runs VERILOG code, each of the secondary threads running a corresponding interpreter that interprets an associated scripted routine, each scripted routine comprising an associated user-defined call that is mapped to a VERILOG task;
providing a plurality of user-defined VERILOG functions, each user-defined function associated with a corresponding interpreter;
upon encountering one of the user-defined functions, passing control from the simulator to the corresponding interpreter to interpret the associated scripted routine; and
upon encountering one of the user-defined calls, passing control from the interpreter to the simulator.
